(19) United States
(12) Patent Application Publication
(10) Pub. No.: US 2026/0044381 A1
(43) Pub. Date: Feb. 12, 2026

(54) ORCHESTRATING QUERIES BASED ON COMPUTING RESOURCE TYPE

(71) Applicant: Cisco Technology, Inc., San Jose, CA (US)

(72) Inventors: Ana Marina Montenegro Galarza, Mexico City (MX); Sudha Katgeri, Allen, TX (US); Amanda Lee Holst, Campbell, CA (US); M. David Hanes, Lewisville, NC (US)

(21) Appl. No.: 18/795,841

(22) Filed: Aug. 6, 2024

(51) Int. Cl. G06F 9/50

(52) U.S. Cl. CPC G06F 9/5044; G06F 9/5038; G06F 9/5083; G06F 2209/5022; G06F 2209/503

(57) ABSTRACT

This disclosure describes techniques for load balancing user queries for artificial intelligence (AI) processing. A user query may be received that is initially destined to be processed by an AI computing resource. The user query may be pre-processed to identify metadata associated with the user query (e.g., attributes, features, characteristics, etc. associated with a user prompt and/or input file of the user query). The metadata may be used to determine processing requirements associated with the user query. The processing requirements may be used to determine whether such processing is to be performed by a non-AI computing resource instead of an AI computing resource. The user query may be load-balanced accordingly, and subsequent output provided to a user in response to the user query.

### TECHNICAL FIELD

The present disclosure relates generally to load balancing user queries for artificial intelligence (AI) processing.

### BACKGROUND

Artificial intelligence (AI) technology continues to be a popular method of accomplishing tasks and has a plethora of applications; the use of AI is applicable to a variety of industries, as well as a variety of aspects in day-to-day lives. For example, AI has applications ranging from testing candidate drug compounds to creating content such as music and art. AI technology continues to be an important and fundamental method for processing and/or performing particular actions as AI technology may provide users with fast, accessible, efficient, and effective ways to accomplish certain tasks. AI technology is also well established as resource used by many enterprises and/or organizations. Many enterprises and/or organizations have implemented their own toolkit of different AI resources to increase employee efficiency, increase customer experience, etc.

Due to the widespread use and necessity of AI technology, many users have defaulted to the use of AI resources for all inquiries, tasks, etc. In other words, AI resources have become a “one-stop shop.” However, AI resources, such as third-party AI software, can be costly for an enterprise and/or organization. As the demand for AI resources has increased, enterprises and/or organizations must also scale the availability of AI resources to meet computing resource needs and avoid latency issues.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment in which an AI taster may pre-process incoming user inquiries and identify whether to process the query with AI computing resources or non-AI computing resources.

FIG. 2 illustrates an example diagram of components of the AI taster and load balancer.

FIG. 3 illustrates a flow diagram for an example process for orchestrating load-balancing between AI computing resources and non-AI computing resources based on attributes associated with a user query.

FIG. 4 illustrates a flow diagram for an example process for orchestrating load-balancing between AI computing resources and non-AI computing resources based on network and/or administrator configurations.

FIG. 5 illustrates a flow diagram of an example method for load balancing user queries for AI processing.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes techniques for pre-processing (or “tasting”) incoming user queries in order to evaluate whether to deploy the user query to AI computing resources or non-AI computing resources. A method to perform the techniques described herein includes receiving, at a network component configured to pre-process queries for AI processing, data indicating a user query for AI processing, and identifying metadata associated with the user query. The method may further include determining, based on at least one of the user query or the metadata, a processing requirement associated with the user query. The method may also include selecting, from among a first computing resource type and a second computing resource type, the first computing resource type as being more suitable for processing the user query than the second computing resource type based at least in part on the processing requirement, wherein the first computing resource type is an AI computing resource and the second computing resource type is a non-AI computing resource. The method may include sending the user query to the first computing resource type based at least in part on the selecting.

Additionally, or alternatively, a method to perform the techniques described herein includes receiving, at a network component configured to pre-process queries for AI processing, data indicating a user query for AI processing, identifying metadata associated with the user query, and determining, based one at least one of the user query or the metadata, a processing requirement associated with the user query. The method may further include selecting, from among a first computing resource type and a second computing resource type, the second computing resource type as being more suitable for processing the user query than the first computing resource type based at least in part on the processing requirement, wherein the first computing resource type is an AI computing resource and the second computing resource type is a non-AI computing resource. The method may also include sending the user query to the second computing resource type based at least in part on the selecting.

Additionally, the techniques described herein may be performed by a system and/or device having non-transitory computer-readable media storing computer-executable instructions that, when executed by one or more processors, performs the method described above.

### EXAMPLE EMBODIMENTS

This disclosure describes techniques for pre-processing (or “tasting”) incoming user queries in order to evaluate whether to deploy the user query to AI computing resources or non-AI computing resources. As discussed above, there are several limitations in the use of AI resources as a “one-stop shop” for user queries. Traditionally, AI resources may be used to accomplish a variety of tasks and/or respond to user queries. Because of this, users typically direct all of their queries to AI resources (e.g., generative AI models) for processing. This may increase costs and inefficiencies associated with the AI resources of an enterprise (e.g., organization, company, business, etc.), and may reduce the availability of AI capabilities of the enterprise for larger and/or more complicated queries. Further, the use and/or availability of AI resources may fluctuate. However, there are some queries that may not require the use AI-capabilities and/or may be optimized for more traditional, non-AI computing resources.

According to the techniques describes herein, a network component, such as an AI taster, may receive data representing a communication from a user and indicating a user query (or other type of user communication) that is to be processed by an AI computing resource (e.g., a generative AI model). The AI taster may identify metadata associated with the user query, which may indicate one or more attributes, features, characteristics, etc. associated with the user query (e.g., attributes associated with the user prompt and/or file included with the user query). The AI taster may then identify, based at least in part on the metadata and/or the user query, one or more processing requirements associated with the user query. For example, the AI taster may determine, based at least in part on the metadata and/or the user query, whether the AI taster is to be processed by a non-AI computing resource (i.e., a “traditional” computing resource) or an AI computing resource. In some instances, while the user query may be intended by the user to be processed by an AI computing resource, the AI taster may determine, based on the metadata, that the user query does not require an AI computing resource and/or may be optimized for a non-AI computing resource. As such, the AI taster may use the processing requirements associated with the user query to determine a computing resource type that is suitable for processing the user query. The computing resource type may include a computing resource (i.e., a non-AI computing resource) instead of an AI computing resource. The AI taster may then send the user query to a load balancer, and may include an indication that the user query is to be processed by the computing resource. In other words, the user query may include a “tag” indicating that the user query is to be processed by a non-AI computing resource. The user query may then be processed accordingly as the load balancer orchestrates the deployment of the user query to the non-AI computing resource.

To implement the techniques described herein, a network component, such as an AI taster, may be configured to perform light-weight pre-processing of user queries for AI processing. For example, the AI taster may receive user queries that are intended to be processed by AI computing resources. For example, a user query may include a user prompt that includes an instruction, request, question, and/or the like. Additionally, or alternatively, the user query may include one or more input files, documents, attachments, and/or the like associated with the user prompt. By way of example, and not limitation, the user query may include a user prompt that includes an instruction to analyze the text of a document. Additionally, or alternatively, the user query may include the document to be analyzed. The user queries may be sent from users associated with an enterprise, and the user queries may be intended to be processed by AI computing resources of the enterprise.

Upon receipt of a user query by the AI taster, the AI taster may be configured to pre-process, or “taste” one or more portions of the user query in order to extract metadata associated with the user query. The metadata may be associated with the user prompt and/or input file included in the user query. Further, the metadata may indicate one or more features, attributes, characteristics, etc., associated with the user query (e.g., the user prompt and/or input file). By way of example, and not limitation, metadata associated the user prompt may include one or more keywords identified by the AI taster. For example, a user prompt may include one or more keywords indicating that the user query pertains to a human resources question. Additionally, or alternatively, the user prompt may include one or more keywords indicating that the user query pertains to a technical question. In this example, the query pertaining to a technical question may be more difficult for a traditional, non-AI computing resource to process, as opposed to the query pertaining to a human resources question. Additionally, or alternatively, the metadata may also include an indication that the user prefers their query to be processed using AI computing resources. For example, a user may specifically request the use of AI computing resources in the user prompt. In one example, the AI taster may be configured to use keywords included in a user prompt, and/or characteristics associated with the input file, to determine an intent of the user (e.g., language translation, log parsing, image analysis, etc.).

In another example, metadata associated with the input file may include one or more features associated with the input file. For example, an input file may include multiple screen shots and/or diagrams. Additionally, or alternatively, the input file may include text at a particular font size and/or resolution. In this example, the user query pertaining to the input file with multiple screen shots and/or diagram may be more difficult for a traditional, non-AI computing resource to process, as opposed to the text at a particular font size and/or resolution that may be optimized for non-AI computing resources. In some instances, the metadata may indicate a feature associated with the file extension and/or format of the input file (e.g., PNG, JPEG, PDF, etc.).

Based on the metadata extracted, and/or identified, by the AI taster, and/or the intent associated with the user query, the AI taster may determine one or more processing requirements associated with the metadata. As described above, certain features, attributes, characteristics, etc. indicated by the metadata of a user query may be optimized for non-AI computing resources. Continuing from the example above, an input file associated with a user query may include text at a particular font size and/or resolution. For example, the input file may be optimized for non-AI computing resources if the text of the input file exceeds a particular font size threshold (e.g., font size 8) and/or a particular resolution threshold (e.g., 300 dots per inch (DPI)). As such, the processing requirements associated with input file may indicate that the user query is optimized to be processed by a non-AI computing resource such as optical character recognition (OCR). Additionally, or alternatively the input file may contain text that is below the particular font size threshold and/or the particular resolution threshold. Accordingly, the processing requirements associated with the input file may indicate that the user query needs to be processed by an AI computing resource.

After determining the processing requirements associated with the metadata of the user query, the AI taster may determine the computing resource type that the user query is to be processed with (i.e., non-AI computing resources or AI computing resources). As described above, traditional, non-AI computing resources may be used for processing certain user queries (e.g., OCR for recognizing text of a certain quality) while AI computing resources may be necessary for other user queries. Examples of computing resources include OCR, standard scripting tools (e.g., Python, JavaScript, etc.), translation tools, log parsing and/or analysis tools, automation tools, machine learning, and/or the like. Examples of AI computing resources include generative AI such as chatbots, text-to-image and text-to-video generators, large language models (LLM), and/or the like. Additionally, or alternatively, the AI taster may determine not only whether the user query is to be processed with non-AI computing resource or AI computing resource, but also a particular category of a non-AI computing resource or AI computing resource. For example, with AI computing resources, an LLM from one third-party service provider may be more optimized for a task than an LLM from a different third-party service provider.

In another example, the AI taster may determine, based on one or more network configurations associated with a service provider network, the computing resource type to process a user query. For example, an administrator associated with an enterprise may provide network configuration data indicating one or more network configurations and/or restrictions. Network configurations and/or restrictions may include a priority associated with a user and/or a user's query (e.g., a user with higher priority may have a user query sent to an AI computing resource, whereas a user with lower priority may have the same user query sent to a non-AI computing resource), a threshold amount of user queries that may be sent to an AI computing resource, the quantity of non-AI and/or AI computing resources that are available, usage data indicating usage patterns associated with non-AI and/or AI computing resources, and/or the like. The network configuration data may be provided to the AI taster continuously and/or periodically.

Once the AI taster has determined the computing resource type the user query is to be processed with (i.e., non-AI computing resources or AI computing resources), then the AI taster may be configured to include an indication of the computing resource type with the user query. For example, the AI taster may “tag” the user data associated with the user query with an indication that the user query is to be processed by a non-AI computing resource or an AI computing resource. To implement the techniques described herein, the AI taster may use, or work in combination with, a load balancer in order to orchestrate the sending of the user query to the appropriate non-AI computing resource or AI computing resource. In some instances, the AI taster and load balancer may be on the same device. The AI taster may be configured to send the data associated with the user query with a tag of the type of computing resource to process and/or otherwise fulfill the user query. Once the load balancer has received the tagged data, the load balancer may be configured to use the user query (e.g., user prompt and input file) and the computing resource type decision of the AI taster and orchestrate the deployment of the user query to the appropriate non-AI computing resource or AI computing resource. In some instances, the load balancer may be configured further process the user query such that the user query may be processed by a particular computing resource type. For example, the load balancer may translate the user query to a particular format that is may be processed by a particular computing resource type. Once the user query is sent to the appropriate non-AI computing resource or AI computing resource, the user query may be processed, and a response and/or output of the non-AI computing resource or AI computing resource may be returned to the user.

In some instances, upon receiving the response and/or the output of the non-AI computing resource or AI computing resource, the AI taster may be configured to receive user input data indicating a response and/or feedback to the output. For example, user input data may include user feedback, where the user feedback may indicate that the response to the user query was insufficient, inaccurate, etc. The AI taster may be configured to use the user input data in determining subsequent computing resource types for user queries. For example, at a first instance, the AI taster may determine, based on the metadata associated with a user query and processing requirements, that a user query is to be processed by a non-AI computing resource. Subsequent to the user query being processed by the non-AI computing resource and an output of the non-computing resource being presented to a user, the user may provide user input data indicating that the response to the user query was inaccurate. Based on the user input data, at a second instance, the AI taster may determine that the same user query is to be processed by an AI computing resource.

Additionally, or alternatively, the AI taster may be configured to determine whether redundant processing is to be used in processing a user query based on a confidence level, or score, associated with an output. For example, in instances where a user query may be processed by both a non-AI computing resource and an AI computing resource, the user query may be sent to the load balancer with an indication that the user query is to be processed by the non-AI computing resource and the AI computing resource. After the user query has been processed and an output generated, the output of the non-AI computing resource and the output of the AI computing resource may be compared. If the output of the non-AI computing resource and the output of the AI computing resource are the same and/or above a threshold level of similarity, the AI computing resource may be associated with a higher confidence score. Additionally, or alternatively, if the output of the non-AI computing resource and the output of the AI computing resource contain discrepancies and/or are below the threshold level of similarity (e.g., the output of the AI computing resource includes a “hallucination”), the AI computing resource may be associated with a lower confidence score. In some instances, based on the AI computing resource being associated with the lower confidence score, the AI taster may be configured to include an indication to the load balancer that a user query is to be processed using an additional, or redundant, AI computing resource of a different source (e.g., a similar AI computing resource of a different third-party service provider). Additionally, or alternatively, the AI taster and/or load balancer may be configured to use retrieval augmented generation (RAG) techniques, where the AI taster may be configured to “taste” certain portions of a user query and extract the related metadata associated with the user prompt and/or input file of the user query. The portions of the user query may be processed by a non-AI computing resource such that additional context associated with the user query is identified. After the portions of the user query are processed by the non-AI computing resource, the AI taster and/or load balancer may be configured to cause further processing of the user query using an AI computing resource. In this way, the output of the AI computing resource that is response to the user query may be more accurate and/or contextually aware.

The techniques described herein provide various improvements and efficiencies with respect to processing user queries for AI computing resources, as well as lowering costs for enterprises and/or customers of AI computing resources. For example, when a user associated with the enterprise sends a user query for processing AI computing resources, load balancing the user query between non-AI computing resources that are able to process and/or fulfill the user query and AI computing resources enables enterprises to scale down the amount of AI computing resources that are required (e.g., CPU, GPU, RAM, etc.) and/or related computing power. Additionally, or alternatively, having a large amount of available AI computing resources may be futile when the use of the AI computing resources may fluctuate (e.g., AI computing resources are more likely to be available during the lunch hour or the middle of the night). Accordingly, the techniques described herein may increase efficiencies in the use of AI computing resource, reduce the number of necessary AI computing resources to be scaled to meet user query demand, and in turn, reduce enterprise and/or customer costs. Additionally, in some instances, using a non-AI computing resource may be more accurate than an AI computing resource. As such, the techniques described herein may better the user experience, despite a tendency for users to default to the use of AI computing resources.

The techniques described herein are with reference to a service provider network, such as a cloud provider network or platform. However, the techniques are equally applicable to any network and in any environment. For example, the AI taster and/or load balancer may be associated with an on-premises network.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations set forth herein. The disclosure encompasses variations of the embodiments as described herein.

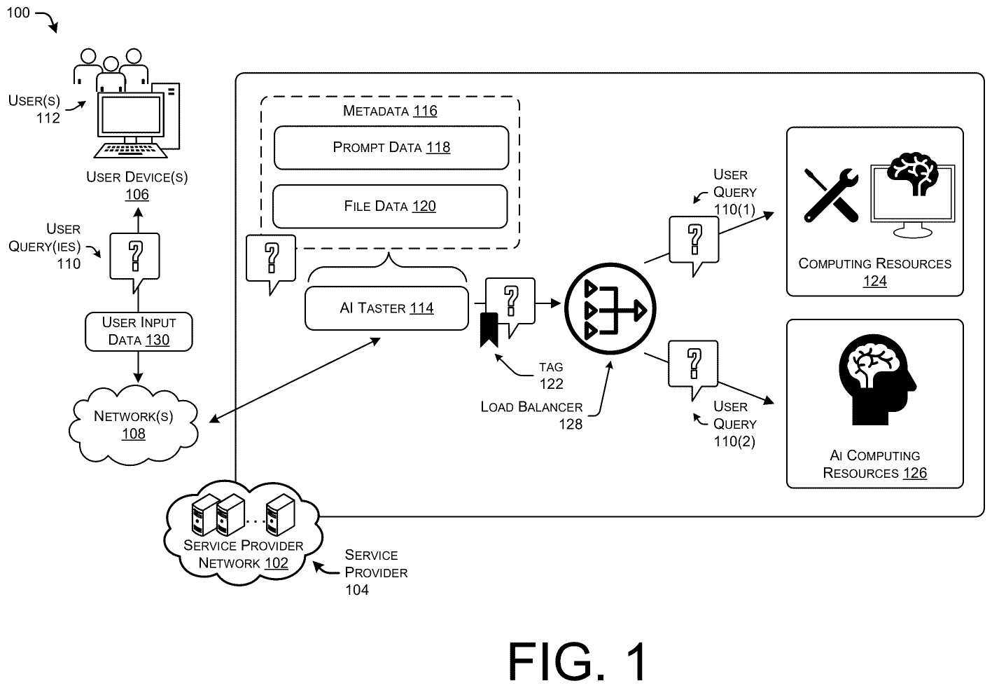

FIG. 1 illustrates an example environment 100 in which an AI taster 114 may pre-process incoming user queries 110 and identify whether to process the query with AI computing resources 126 or non-AI computing resources 124.

In some examples, the service provider network 102 of a service provider 104 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 102 may be an on-premises network, a private network of a corporation, and/or any other type of network or combination thereof.

In some instances, the AI taster 114 may be a scalable service that includes and/or runs on devices houses or located in one or more data centers that may be located at different physical locations. The AI taster 114 may be supported by networks of devices in a public cloud computing platform, a private/enterprise computing platform, and/or any combination thereof. The one or more data centers may be physical facilities or buildings located across geographic areas that are designated to store network devices that are part of and/or support the AI taster 114. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The AI taster 114 may receive data indicating a user query 110 from a user 112 of a user device 106, where the user query 110 is sent by the user 112 to be processed by AI computing resources 126. User device(s) 106 may communicate over network(s) 108, such as the Internet. In some instances, the network(s) 108 may generally comprise one or more networks implemented by any viable communication technology, such as wired and/or wireless modalities and/or technologies. The network(s) 108 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 108 may include devices, virtual resources, or other nodes that relay packets from one device to another. The user device(s) 106 may comprise any type of electronic device capable of communicating using email communications. For instance, the user device(s) 106 may include one or more of different personal user devices, such as desktop computers, laptop computers, phones, tablets, wearable devices, entertainment devices such as televisions, and/or any other type of computing device.

The AI taster 114 may be configured to receive user queries 110 that are destined for an AI computing resource 126 and perform light-weight pre-processing of the user queries 110. Upon receipt of a user query 110, the AI taster 114 may “taste” one or more portions of the user query 110 in order to extract metadata 116 associated with the user query 110. The metadata 116 may be associated with user prompt data 118 and/or file data 120 included in the user query 110. Further, the metadata may indicate one or more features, attributes, characteristics, etc., associated with the user query 110 (e.g., one or more features, attributes, characteristics, etc., associated with prompt data 118 and/or file data 120). By way of example, and not limitation, metadata 116 such as prompt data 118 may include one or more keywords identified by the AI taster 114 included a user prompt associated with the user query 110. For example, prompt data 118 may indicate one or more keywords included in a user prompt and indicating that the user query 110 pertains to a particular task, subject matter, etc. In some instances, the prompt data 118 may also include an indication that the user 112 prefers that the user query 110 be processed using AI computing resources 126. For example, the user 112 may prefer that the user query 110 be processed using AI computing resources 126 due to the nature of the user query 110 (e.g., the user query 110 involves information of particular importance).

In another example, metadata 116 may include file data 120. For example, file data 120 may include one or more features identified by the AI taster 114 that is included in the input file associated with the user query 110. For example, the file data 120 may indicate that the input file includes multiple screen shots and/or diagrams. Additionally, or alternatively, the file data 120 may indicate that the input file includes text at a particular font size and/or resolution. In some instances, the file data 120 may indicate a feature associated with the file extension and/or format of the input file (e.g., PNG, JPEG, PDF, etc.).

Based on the metadata 116, the AI taster 114 may be configured to determine one or more processing requirements associated with the metadata 116. As described above, certain features, attributes, characteristics, etc. indicated by the metadata 116 of a user query 110 may be optimized for non-AI computing resources 124 and may not require the use of AI computing resources 126. Continuing from the example above, an input file associated with a user query 110 may include text at a particular font size and/or resolution. For example, the input file may be optimized for non-AI computing resources 124 if the text of the input file exceeds a particular font size threshold (e.g., font size 8) and/or a particular resolution threshold (e.g., 300 dots per inch (DPI)). As such, the processing requirements associated with input file may indicate that the user query 110 is optimized to be processed by a non-AI computing resource 124 such as optical character recognition (OCR). Additionally, or alternatively the input file may contain text that is below the particular font size threshold and/or the particular resolution threshold. Accordingly, the processing requirements associated with the input file may indicate that the user query 110 needs to be processed by an AI computing resource 126. In some instances, such as when the prompt data 118 includes an indication that the user 112 prefers that the user query 110 be processed using AI computing resources 126, the AI taster 114 may refrain from determining the one or more processing requirements associated with the user query 110, and may automatically determine that the user query 110 is to be processed by AI computing resources 126.

After determining the processing requirements associated with the metadata 116 of the user query 110, the AI taster 114 may determine what computing resource type the user query is to be processed with (i.e., non-AI computing resources 124 or AI computing resources 126). As described above, traditional, non-AI computing resources 124 may be used for processing certain user queries (e.g., OCR for recognizing text of a certain quality) while AI computing resources 126 may be necessary for other user queries.

Once the AI taster 114 has determined the computing resource type the user query is to be processed with (i.e., non-AI computing resources 124 or AI computing resources 126), then the AI taster 114 may be configured to include an indication of the computing resource type with the user query 110. For example, the AI taster may “tag” the user data associated with the user query 110 with a tag 122 indicating that the user query 110 is to be processed by a non-AI computing resource 124 or an AI computing resource 126. To implement the techniques described herein, the AI taster 114 may use, or work in combination with, a load balancer 128 in order to orchestrate the sending of the user query 110 to the appropriate non-AI computing resource 124 or AI computing resource 126. In some instances, the AI taster 114 and load balancer 128 may be on the same device. The AI taster 114 may be configured to send the data associated with the user query 110 with a tag 122 of the type of computing resource to process and/or otherwise fulfill the user query 110. Once the load balancer 128 has received the user query 110 and tag 122, the load balancer 128 may be configured to use the user query 110 (e.g., user prompt and input file indicated by prompt data 118 and file data 120) and the computing resource type decision (e.g., tag 122) of the AI taster 114 and orchestrate the sending of the user query 110 to the appropriate non-AI computing resource 124 or AI computing resource 126. In some instances, the load balancer 128 may be configured further process the user query 110 such that the user query 110 may be processed. For example, the load balancer 128 may translate the user query 110 to a particular format that is may be processed by a particular computing resource type. Once the user query is sent to the appropriate non-AI computing resource 124 or AI computing resource 126, the user query 110 may be processed, and a response and/or output of the non-AI computing resource 124 or AI computing resource 126 may be returned to the user 112.

In some instances, upon receiving the response and/or the output of the computing resources 124 or AI computing resources 126, the AI taster 114 may be configured to receive user input data 130 indicating a response and/or feedback to the output. For example, user input data 130 may include user feedback, where the user feedback may indicate that the response to the user query 110 was insufficient, inaccurate, etc. The AI taster 114 may be configured to use the user input data 130 in determining subsequent computing resource types for user queries 110.

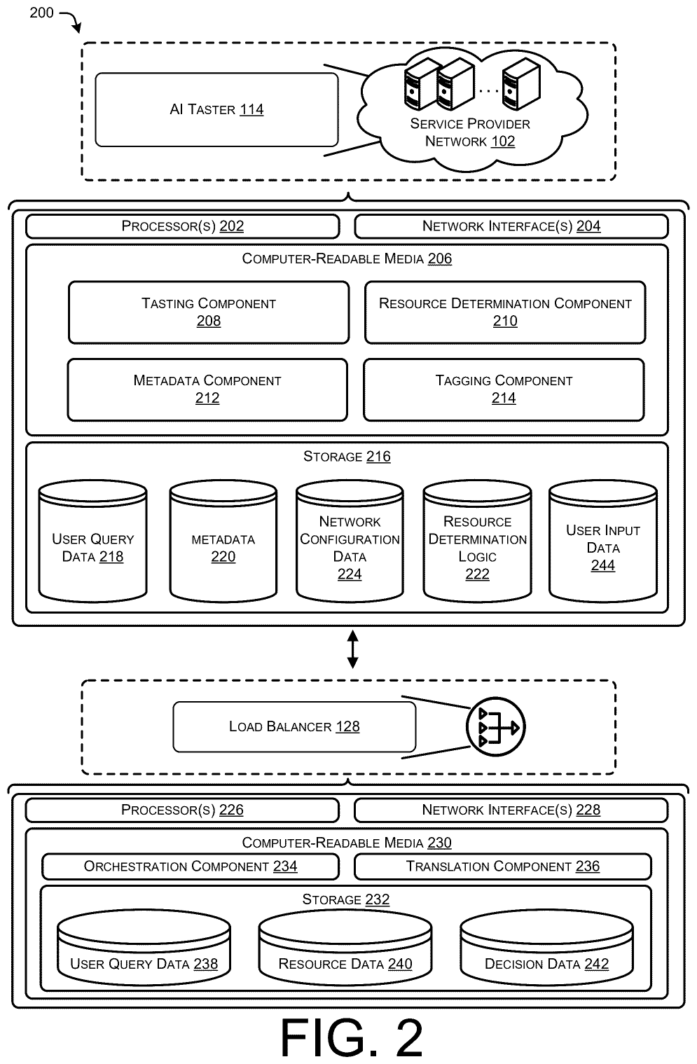

FIG. 2 illustrates an example diagram 200 of components of the AI taster 114 and load balancer 128. Although depicted separately, the AI taster 114 and load balancer 128 may be configured on the same device. As illustrated, the service provider network 102 may be associated the AI taster 114. The AI taster 114 may include one or more hardware processor(s) 202 (processors) configured to execute one or more stored instructions. The processors 202 may comprise one or more cores. Further, the AI taster 114 may include network interface(s) 204 to allow the processor 202 or other portions of the AI taster 114 to communicate with other devices. The network interface(s) 204 may comprise Inter-Integrated Circuit (I2C), Serial Peripheral Interface bus (SPI), Universal Serial Bus (USB) as promulgated by the USB Implementers Forum, RS-232, and so forth. The network interface(s) 204 may include devices configured to couple to personal area networks (PANs), wired and wireless local area networks (LANs), wired and wireless wide area networks (WANs), and so forth. For example, the network interface(s) 204 may include devices compatible with Ethernet, Wi-Fi™, and so forth.

AI taster 114 may also include computer-readable media 206 that stores various executable components (e.g., software-based components, firmware-based components, etc.). In addition to various components discussed in FIG. 1, the computer-readable media 206 may further store components to implement functionality described herein. While not illustrated, the computer-readable media 206 may store one or more operating systems utilized to control the operation of the one or more devices that comprise the AI taster 114. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 206 may include a tasting component 208 that configures the AI taster 114 to perform various operations described herein. For instance, the tasting component 208 may be configured to, when executed by the processors 202, perform various techniques to pre-process and/or “taste” one or more portions of a user query. For example, in instances where an input file associated with a user query includes multiple lines of text, the tasting component 208 may be configured to identify a portion of the multiple lines of text. Additionally, or alternatively, the tasting component 208 may be configured to identify one or more portions of data included in a user query, such as data included in a user prompt and/or input file. In some instances, the tasting component 208 may be configured to identify one or more portions of data included in multiple user queries, and/or when a user query may contain multiple input files. This way, the tasting component 208 is able to identify one or more portions of data to extract metadata from, as opposed to having to analyze an entire input file. The computer-readable media 206 may also include a metadata component 212 that configures the AI taster 114 to perform various operations described herein. For instance, the metadata component 212 may be configured to, when executed by the processors 202, perform various techniques for extracting and/or determining metadata associated with a user query. For example, the metadata may include an indication of one or more features associated with a user prompt and/or input file of a user query. For example, the metadata component 212 may utilize data indicating a keyword included in a user prompt, a type of language included in an input file, text resolution, and/or the like.

The computer-readable media 206 may also include a resource determination component 210 that configures the AI taster 114 to perform various operations described herein. For instance, the resource determination component 210 may use, or work in combination with, the metadata component 212 to determine whether a user query is able to be processed by a non-AI computing resource instead of an AI computing resource. For example, the metadata extracted by the metadata component 212 may indicate that the user query relates to software-defined networking deployment. Accordingly, the resource determination component may determine that the user query is to be processed by an AI computing resource due to the complex nature of software-defined networking deployment. The computer-readable media 206 may also include a tagging component 214 that configures the AI taster 114 to perform various operations described herein. For instance, the tagging component 214 may be configured to “tag” and/or otherwise indicate a determination on whether a user query is to be processed by a non-AI computing resource or an AI-computing resource, such that the user query and tag may be sent to the load balancer 128.

Additionally, the AI taster 114 may include storage 216 which may comprise one, or multiple, repositories or other storage locations for persistently storing and managing collections of data such as databases, simple files, binary, and/or any other data. The storage 216 may include one or more storage locations that may be managed by one or more storage/database management systems.

As illustrated, the storage 216 may include user query data 218, metadata 220, network configuration data 224, resource determination logic 222, and/or user input data 244. It should be appreciated that the foregoing list is merely exemplary and the storage 216 may include additional elements that may be apparent to one skilled in the art.

The user query data 218 may include a database of user queries that are received by the AI taster 114. For example, the user query data 218 may include data representing a user prompt (e.g., instruction, question, etc.) included in a user query and an input file included with the user query. The metadata 220 may include a database representing one or more features associated with a user query and extracted by the AI taster 114. For example, the metadata 220 may include data representing one or more features, characteristics, attributes, etc. associated with a user query. The metadata 220 may include an indication of an intent associated with the user query, keywords associated with the user prompt, subject matter associated with the user query, features associated with the input file, a file extension associated with the input file, and/or the like. The network configuration data 224 may include a database of network configurations received by the AI taster 114 that may be used to identify a computing resource type for processing a user query. For example, the network configurations may include a priority associated with a user and/or a user's query, a threshold amount of user queries that may be sent to an AI computing resource, the quantity of non-AI and/or AI computing resources that are available, usage data indicating usage patterns associated with non-AI and/or AI computing resources, and/or the like. The user input data 244 may include a database of user input that is received by the AI taster 114 in response to the output of a non-AI computing resource and/or AI computing resource. For example, user input data may include user feedback, where the user feedback may indicate that the response to the user query was insufficient, inaccurate, etc.

The resource determination logic 222 may include a database of logic for determining a computing resource type (e.g., a non-AI computing resource or an AI computing resource) for processing a user query. For example, the resource determination component 210 may reference the metadata 220, network configuration data 224, user input data 244, and/or resource determination logic 222 in determining whether a user query is to be processed by a non-AI computing resource or an AI computing resource.

As illustrated, the load balancer 128 may include one or more hardware processor(s) 226 (processors) configured to execute one or more stored instructions. The processors 226 may comprise one or more cores. Further, the load balancer 128 may include network interface(s) 228 to allow the processor 226 or other portions of the load balancer 128 to communicate with other devices. The network interface(s) 228 may comprise Inter-Integrated Circuit (I2C), Serial Peripheral Interface bus (SPI), Universal Serial Bus (USB) as promulgated by the USB Implementers Forum, RS-232, and so forth. The network interface(s) 228 may include devices configured to couple to personal area networks (PANs), wired and wireless local area networks (LANs), wired and wireless wide area networks (WANs), and so forth. For example, the network interface(s) 228 may include devices compatible with Ethernet, Wi-Fi™, and so forth.

The load balancer 128 may include computer-readableable media 230 that stores various executable components (e.g., software-based components, firmware-based components, etc.). In addition to various components discussed in FIG. 1, the computer-readable media 230 may further store components to implement functionality described herein. While not illustrated, the computer-readable media 230 may store one or more operating systems utilized to control the operation of the one or more devices that comprise the load balancer 128. The operating systems may implement a variant of the FreeBSD™ operating system as promulgated by the FreeBSD Project; other UNIX™ or UNIX-like variants; a variation of the Linux™ operating system as promulgated by Linus Torvalds; the Windows® Server operating system from Microsoft Corporation of Redmond, Washington, USA; and so forth.

The computer-readable media 230 may include an orchestration component 234 that configures the load balancer 128 to perform various operations described herein. For instance, the orchestration component 234 may be configured to, when executed by the processors 226, perform various techniques to orchestrate the sending of user queries to a non-AI computing resource or AI computing resource. For example, based on the availability of computing resources, computing resource type determined by the AI taster 114, and the user query (including the user prompt and input file(s)), the load balancer 128 may be configured to send the user query to a particular non-AI computing resource or a particular non-AI computing resource. The computer-readable media 230 may also include a translation component 236 that configures the load balancer 128 to perform various operations described herein. For instance, the translation component 236 may be configured to, when executed by the processors 226, translate a user query into a particular format so that the user query may be processed using a particular non-AI computing resource.

Additionally, the load balancer 128 may include storage 232 which may comprise one, or multiple, repositories or other storage locations for persistently storing and managing collections of data such as databases, simple files, binary, and/or any other data. The storage 232 may include one or more storage locations that may be managed by one or more storage/database management systems.

As illustrated, the storage 232 may include user query data 238, resource data 240, and/or decision data 242. It should be appreciated that the foregoing list is merely exemplary and the storage 232 may include additional elements that may be apparent to one skilled in the art.

The user query data 218 may include a database of user queries that are received by the AI taster 114. For example, the user query data 218 may include data representing a user prompt (e.g., instruction, question, etc.) included in a user query and an input file included with the user query. The resource data 240 may include a database of available non-AI computing resources and AI computing resources in a service provider network and/or associated with an enterprise. For example, the resource data 240 may indicate that non-AI computing resources such as scripting and/or OCR are available as well as AI computing resources. The decision data 242 may include a database of the tags (e.g., decisions) provided by the AI taster 114 and indicating the computing resource type that is to process a user query.

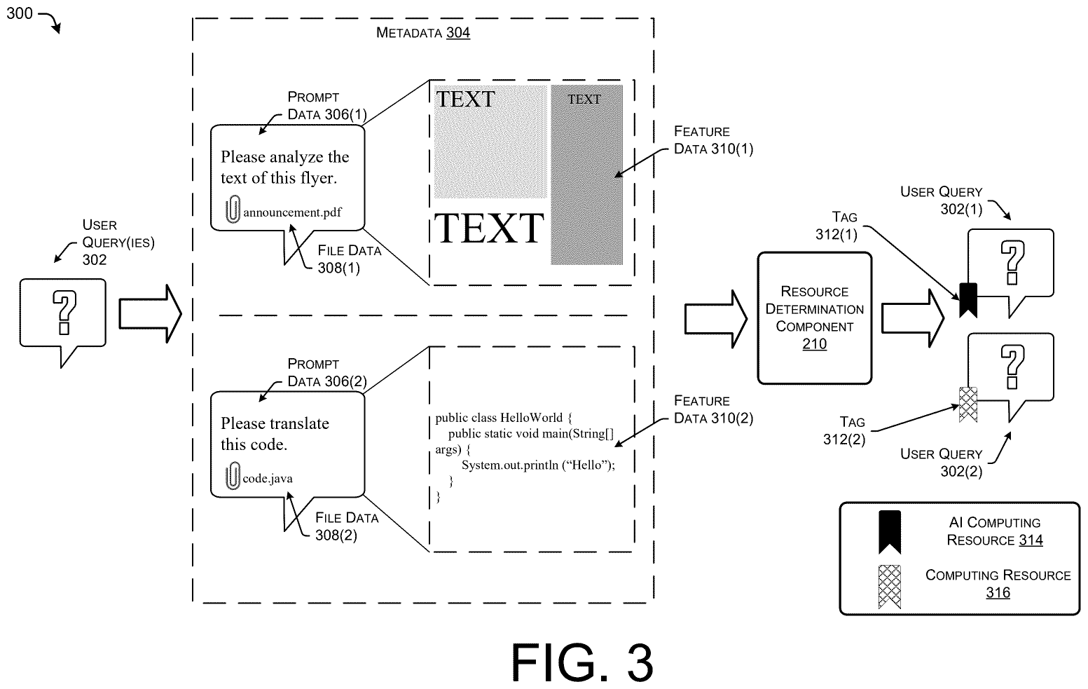

FIG. 3 illustrates a flow diagram for an example process 300 for orchestrating load-balancing between AI computing resources 314 and non-AI computing resources 316 based on attributes associated with a user query 302.

As described above, the AI taster may be configured to pre-process, or “taste” one or more portions of the user query in order to extract metadata 304 associated with the user query 302. The user query 302 may contain prompt data 306, file data 308, and/or feature data 310. Additionally, or alternatively, based on the prompt data 306, file data 308, and/or feature data 310, the AI taster may be configured a user intent associated with the user query 302 (e.g., a task associated with the user query 302). Tasks may include, but are not limited to, image analysis, language translation, log parsing, network monitoring and performance analytics, network anomaly detection and predictive maintenance, and/or the like. As illustrated, the metadata 304 may indicate one or more features, attributes, characteristics, etc., associated with the user query 302, such as prompt data 306, file data 308, and/or feature data 310. In some instances, prompt data 306 may include one or more keywords identified by the AI taster. For example, prompt 306(1) may include one or more keywords indicating that the user query 302 pertains to image analysis (e.g., “analyze” and “flyer”). In another example, prompt 306(1) may include one or more keywords indicating that the user query 302 pertains to translation (e.g., “translate”).

Additionally, or alternatively, file data 308 may contain one or more features, attributes, characteristics, etc. associated with an input file included with the user query 302. For example, the file data 308 may indicate a file format and/or extension type, which may be used by the AI taster in determining whether the user query 302 is to be processed by a non-AI computing resource 316 or AI computing resource 314. File formats and/or extension types may include, but are not limit to, PDF, GIF, JPEG, HTML, DOCX, and/or the like. As illustrated, file data 308(1) may indicate that the file format associated with the input file is a PDF, and file data 308(2) may indicate that the file format associated with the input file is a Java language file.

In some instances, the metadata 304 may include feature data 310 indicating one or more features, attributes, characteristics, etc. associated with an input file included with the user query 302. For example, feature data 310 may indicate features associated with the contents of the input file. Features associated with the contents of the input file may include, but are not limited to, font size, resolution, background noise, text, and/or any type of general features that may be used by the AI taster to determine processing requirements associated with the user query 302. As illustrated, in the example where prompt data 306(1) indicates a task for image analysis, feature data 310(1) may be used by the AI taster to determine the resolution of the image (e.g., DPI), the font size of the text, the contract between the background and the text, and/or the like. In the example where prompt data 306(2) includes a task for translation, feature data 310(2) may be used by the AI taster to determine parameters of the code to determine a language match.

Based on the metadata 304 including prompt data 306, file data 308, and/or feature data 310, the AI taster may use, or work in combination with, the resource determination component 210 in order to identify whether the user query 302 is to be processed using an AI computing resource 314 or a non-AI computing resource 316. For example, based on the metadata 304, the resource determination component 210 may determine one or more processing requirements associated with the user query 302, and determine the computing resource type to process the user query 302 accordingly. In examples where user query 302 may contain prompt data 306(1), file data 308(1), and/or feature data 310(1), the resource determination component 210 may determine that the processing requirements associated with the user query 302 may not be optimized for a non-AI computing resource 316. For example, in instances where feature data 310(1) indicates that font size is too small, DPI is too low, and/or the contrast between the background and text is too low, the resource determination component 210 may determine that the user query 302 is not optimized for processing by a non-AI computing resource, such as OCR. Instead, the user query 302 is to be processed by an AI computing resource 314. In examples where user query 302 may contain prompt data 306(2), file data 308(2), and/or feature data 310(2), the resource determination component 210 may determine that the processing requirements associated with the user query 302 may be optimized for a non-AI computing resource 316. For example, in instances where feature data 310(2) indicates the input file contains generic code and the resource determination component 210 is able to determine a language match, the AI taster and/or resource determination component 210 may be able to perform a look-up to determine whether the language tested may be translated with a non-AI computing resource 316. For example, the feature data 310(2) may indicate that the input file contains Java programming language, and may be optimized to be translated with non-AI computing resources 316 such as Google Translate.

In some instances, the resource determination component 210 may be unable to determine whether the user query 302 is to be processed using an AI computing resource 314 or a non-AI computing resource 316. In instances where the resource determination component 210 is unable to make a determination, the resource determination component 210 may default to determining that every user query 302 is to be processed by an AI computing resource 314.

Once the resource determination component 210 has determined the appropriate computing resource type (e.g., AI computing resource 314 and/or non-AI computing resource 316), the AI taster may be configured to “tag” and/or otherwise include an indication with the user query 302 the decision of the resource determination component 210 and the computing resource type to process the user query 302. Continuing from the example above, user query 302(1), which may be associated with metadata 304 indicating that the query 302(1) is unable to be processed with OCR, may be associated with tag 312(1) indicating that the user query 302(1) is to be processed using an AI computing resource 314. Additionally, or alternatively, user query 302(2), which may be associated with metadata 304 indicating that the query 302(2) is able to be processed with Google Translate, may be associated with tag 312(2) indicating that the user query 302(2) is to be processed using a non-AI computing resource 316. As described above, the user query 302(1) with tag 312(1) and/or user query 302(2) with tag 312(2) may further be sent to a load balancer and subsequently processed. While FIG. 3 illustrates a tag 312 associated with an entire user query 302, it is to be noted that the resource determination component 210 may be configured to determine that certain portions of a user query 302 may be processed using AI computing resources 314, while other portions of the same user query 302 may be processed using non-AI computing resources 316.

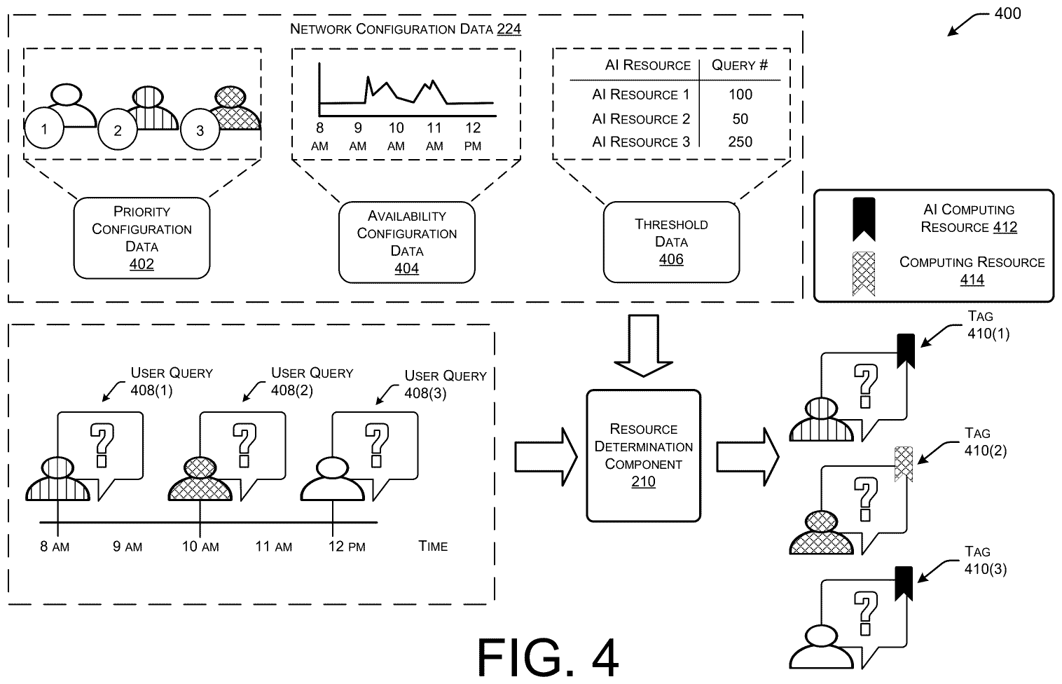

FIG. 4 illustrates a flow diagram for an example process 400 for orchestrating load-balancing between AI computing resources 412 and non-AI computing resources 414 based on network and/or administrator configurations, such as network configuration data 224.

As described above, the AI taster may use, or work in combination with, the resource determination component 210 to determine whether a user query 408 is to be processed by an AI computing resource 412 or a non-AI computing resource 414 based at least in part on one or more network configurations associated with a service provider network. For example, an administrator associated with an enterprise may provide network configuration data 224 indicating one or more network configurations and/or restrictions, which may be used by the resource determination component 210 in determining the computing resource type that is able to process a user query 408. For example, the network configuration data 224 may include priority configuration data 402, availability configuration data 404, and/or threshold data 406. As illustrated, priority configuration data 402 may include a priority associated with, or assigned to, a user and/or a user's query. For example, a user with a higher priority may be more likely to have their user query processed using an AI computing resource 412 than a user with a lower priority, even if the user queries are for the same or a similar task. Additionally, or alternatively, a particular user query may have a higher priority than other user queries (e.g., a user query associated with subject matter that is deemed more critical and/or important for the enterprise may have a higher priority).

Additionally, or alternatively, the network configuration data 224 may include availability configuration data 404. Availability configuration data 404 may include an indication of the general availability of AI computing resources 412 and/or non-AI computing resources 414, as well as usage patterns associated with the availability of AI computing resources 412 and/or non-AI computing resources. For example, usage patterns may indicate that AI computing resources 412 are highly utilized from the hours of 9 AM until 12 PM, but are less utilized during the hours of 8 AM and 12 PM. Additionally, or alternatively, the network configuration data 224 may include threshold data 406. The threshold data 406 may include an indication of a threshold amount of user queries 408 that may be sent to an AI computing resource 412. For example, a first AI computing resource 412 may be configured, by a network administrator, to receive no more than 100 user queries 408, a second AI computing resource 412 may be configured to receive no more than 50 user queries 408, and/or a third AI computing resource 412 may be configured to receive no more than 250 user queries 408. In some instances, based on a number of user queries 408 exceeding a threshold of an AI computing resource 412, the resource determination component 210 may still determine to process user queries 408 with an AI computing resource 412 with an exceeded limit, but the AI taster may cause a notification to be send to a network administrator and/or user indicating that the threshold has been exceeded.

As illustrated in FIG. 4, the AI taster may receive user query 408(1), 408(2), and/or 408(3) from different users at different times. The AI taster may use, or work in combination with, the resource determination component 210 to determine whether the user queries 408 are to be processed by an AI computing resource 412 or a non-AI computing resource 414 based at least in part on the network configuration data 224. In some instances, the resource determination component 210 may use the network configuration data 224 in combination with metadata associated with the user queries 408 to determine a type of computing resource. For example, the AI taster may receive user query 408(1) at 8 AM. The resource determination component 210 may determine, based on the network configuration data 224, that priority configuration data 402 indicates that the user associated with the user query 408(1) has a second, and/or middle, priority, and/or that availability configuration data 404 indicates that there is low usage of AI computing resources 412 at 8 AM. Accordingly, the resource determination component 210 may determine that the user query 408(1) is to be processed by an AI computing resource 412, and include a tag 410(1) with the user query 408(1) of this determination. Additionally, or alternatively, the AI taster may receive user query 408(2) at 10 AM. The resource determination component 210 may determine, based on the network configuration data 224, that priority configuration data 402 indicates that the user associated with the user query 408(2) has a third, and/or low, priority, and/or that availability configuration data 404 indicates that there is high usage of AI computing resources 412 at 10 AM. Accordingly, the resource determination component 210 may determine that the user query 408(2) is to be processed by a non-AI computing resource 414, and include a tag 410(2) with the user query 408(2) of this determination. Additionally, or alternatively, the AI taster may receive user query 408(3) at 12 PM. The resource determination component 210 may determine, based on the network configuration data 224, that priority configuration data 402 indicates that the user associated with the user query 408(3) has a first, and/or high, priority, and/or that availability configuration data 404 indicates that there is a low usage of AI computing resources 412 at 12 PM. Accordingly, the resource determination component 210 may determine that the user query 408(3) is to be processed by an AI computing resource 412, and include a tag 410(3) with the user query 408(3) of this determination.

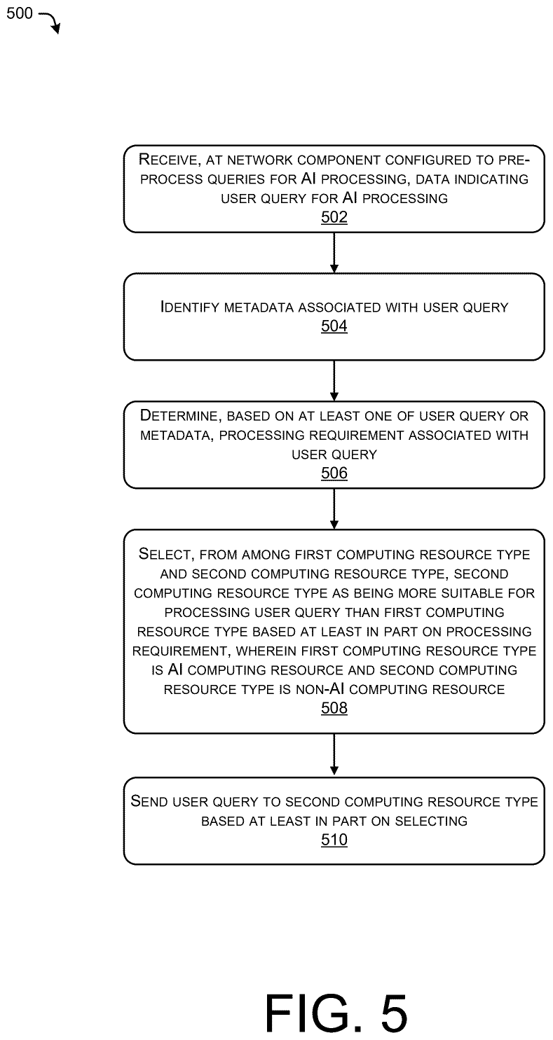

FIG. 5 illustrates a flow diagram of an example method 500 for pre-processing user queries for AI processing, and determining, based at least in part on metadata associated with the user queries, that the user query may be processed by a non-AI computing resource instead of an AI computing resource. The techniques may be applied by a system comprising one or more processors, and one or more non-transitory computer-readable media storing computer-executable instructions that, when executed by the one or more processors, cause the one or more processors to perform the operations of method 500.

The processes described herein are illustrated as collections of blocks in logical flow diagrams, which represent a sequence of operations, some or all of which may be implemented as hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 502, the method 500 may include receiving, at a network component configured to pre-process queries for AI processing, data indicating a user query for AI processing. For example, a network component, such as an AI taster, may be configured to perform light-weight pre-processing of user queries for AI processing. For example, the AI taster may receive user queries that are intended to be processed by AI computing resources. For example, a user query may include a user prompt that includes an instruction, request, question, and/or the like. Additionally, or alternatively, the user query may include one or more input files, documents, attachments, and/or the like associated with the user prompt. By way of example, and not limitation, the user query may include a user prompt that includes an instruction to analyze the text of a document. Additionally, or alternatively, the user query may include the document to be analyzed. The user queries may be sent from users associated with an enterprise, and the user queries may be intended to be processed by AI computing resources of the enterprise.

At block 504, the method 500 may include identifying metadata associated with the user query. For example, the AI taster may be configured to pre-process, or “taste” one or more portions of the user query in order to extract metadata associated with the user query. The metadata may be associated with the user prompt and/or input file included in the user query. Further, the metadata may indicate one or more features, attributes, characteristics, etc., associated with the user query (e.g., the user prompt and/or input file). By way of example, and not limitation, metadata associated the user prompt may include one or more keywords identified by the AI taster. For example, a user prompt may include one or more keywords indicating that the user query pertains to a human resources question. Additionally, or alternatively, the user prompt may include one or more keywords indicating that the user query pertains to a technical question. In this example, the query pertaining to a technical question may be more difficult for a traditional, non-AI computing resource to process, as opposed to the query pertaining to a human resources question. Additionally, or alternatively, the metadata may also include an indication that the user prefers their query to be processed using AI computing resources. For example, a user may specifically request the use of AI computing resources in the user prompt. In one example, the AI taster may be configured to use keywords included in a user prompt, and/or characteristics associated with the input file, to determine an intent of the user (e.g., language translation, log parsing, image analysis, etc.).

In another example, metadata associated with the input file may include one or more features associated with the input file. For example, an input file may include multiple screen shots and/or diagrams. Additionally, or alternatively, the input file may include text at a particular font size and/or resolution. In this example, the user query pertaining to the input file with multiple screen shots and/or diagram may be more difficult for a traditional, non-AI computing resource to process, as opposed to the text at a particular font size and/or resolution that may be optimized for non-AI computing resources. In some instances, the metadata may indicate a feature associated with the file extension and/or format of the input file (e.g., PNG, JPEG, PDF, etc.).

At block 506, the method 500 may include determining, based on at least one of the user query or the metadata, a processing requirement associated with the user query. For example, based on the metadata extracted, and/or identified, by the AI taster, and/or the intent associated with the user query, the AI taster may determine one or more processing requirements associated with the metadata. As described above, certain features, attributes, characteristics, etc. indicated by the metadata of a user query may be optimized for non-AI computing resources. Continuing from the example above, an input file associated with a user query may include text at a particular font size and/or resolution. For example, the input file may be optimized for non-AI computing resources if the text of the input file exceeds a particular font size threshold (e.g., font size 8) and/or a particular resolution threshold (e.g., 300 dots per inch (DPI)). As such, the processing requirements associated with input file may indicate that the user query is optimized to be processed by a non-AI computing resource such as optical character recognition (OCR). Additionally, or alternatively the input file may contain text that is below the particular font size threshold and/or the particular resolution threshold. Accordingly, the processing requirements associated with the input file may indicate that the user query needs to be processed by an AI computing resource.

At block 508, the method 500 may include selecting, from among a first computing resource type and a second computing resource type, the second computing resource type as being more suitable for processing the user query than the first computing resource type based at least in part on the processing requirement, wherein the first computing resource type is an AI computing resource and the second computing resource type is a non-AI computing resource. For example, after determining the processing requirements associated with the metadata of the user query, the AI taster may determine the computing resource type that the user query is to be processed with (i.e., non-AI computing resources or AI computing resources). As described above, traditional, non-AI computing resources may be used for processing certain user queries (e.g., OCR for recognizing text of a certain quality) while AI computing resources may be necessary for other user queries. Examples of computing resources include OCR, standard scripting tools (e.g., Python, JavaScript, etc.), translation tools, log parsing and/or analysis tools, automation tools, machine learning, and/or the like. Examples of AI computing resources include generative AI such as chatbots, text-to-image and text-to-video generators, large language models (LLM), and/or the like. Additionally, or alternatively, the AI taster may determine not only whether the user query is to be processed with non-AI computing resource or AI computing resource, but also a particular category of a non-AI computing resource or AI computing resource. For example, with AI computing resources, an LLM from one third-party service provider may be more optimized for a task than an LLM from a different third-party service provider.

At block 510, the method 500 may include sending the user query to the second computing resource type based at least in part on the selecting. For example, once the AI taster has determined the computing resource type the user query is to be processed with (i.e., non-AI computing resources or AI computing resources), then the AI taster may be configured to include an indication of the computing resource type with the user query. For example, the AI taster may “tag” the user data associated with the user query with an indication that the user query is to be processed by a non-AI computing resource or an AI computing resource. To implement the techniques described herein, the AI taster may use, or work in combination with, a load balancer in order to orchestrate the sending of the user query to the appropriate non-AI computing resource or AI computing resource. In some instances, the AI taster and load balancer may be on the same device. The AI taster may be configured to send the data associated with the user query with a tag of the type of computing resource to process and/or otherwise fulfill the user query. Once the load balancer has received the tagged data, the load balancer may be configured to use the user query (e.g., user prompt and input file) and the computing resource type decision of the AI taster and orchestrate the deployment of the user query to the appropriate non-AI computing resource or AI computing resource. In some instances, the load balancer may be configured further process the user query such that the user query may be processed by a particular computing resource type. For example, the load balancer may translate the user query to a particular format that is may be processed by a particular computing resource type. Once the user query is sent to the appropriate non-AI computing resource or AI computing resource, the user query may be processed, and a response and/or output of the non-AI computing resource or AI computing resource may be returned to the user.

Additionally, or alternatively, the method 500 may include receiving, at the network component, user input data, wherein the user input data is responsive to a first output associated with the second user query and the first computing resource type, selecting, from among the first computing resource type and the second computing resource type, the second computing resource type for processing the second user query based at least in part on the user input data, and sending the user query to be processed by the second computing resource type based at least in part on the selecting. Additionally, or alternatively, determining a comparison between the first output and a second output associated with the second user query and the first computing resource type, and determining a confidence score associated with the first computing resource type based at least in part on the comparison.

Additionally, or alternatively, the method 500 may include wherein the data is first data indicating a first user query, the processing requirement is a first processing requirement, and the metadata is first metadata, receiving, at the network component, user input data, wherein the user input data is responsive to an output associated with the first user query and the second computing resource type, and receiving, at the network component, second data indicating a second user query for AI processing. The method 500 may further include identifying second metadata associated with the second user query, determining, based on at least one of the second user query or the second metadata, a second processing requirement associated with the second user query, and selecting, from among the first computing resource type and the second computing resource type, the first computing resource type as being more suitable for processing the second user query than the second computing resource type based at least in part on the second processing requirement and the user input data, and sending the second user query to the first computing resource type based at least in part on the selecting.

Additionally, or alternatively, the method 500 may include wherein the metadata includes an indication of a feature associated with a file included with the user query, a file extension associated with the file, and/or a feature associated with a user prompt included with the user query.

Additionally, or alternatively, the method 500 may include receiving, at the network component, configuration and indicating a configuration associated with a network and determining, based at least in part on the processing requirement and the configuration data, the second computing resource type as being more suitable for processing the user query.

Additionally, or alternatively, the method 500 may include wherein the configuration includes a threshold usage associated with the AI computing resource, a threshold time associated with the AI computing resource, a priority associated with a user, a priority associated with the user query, and/or computing resources available in the network.

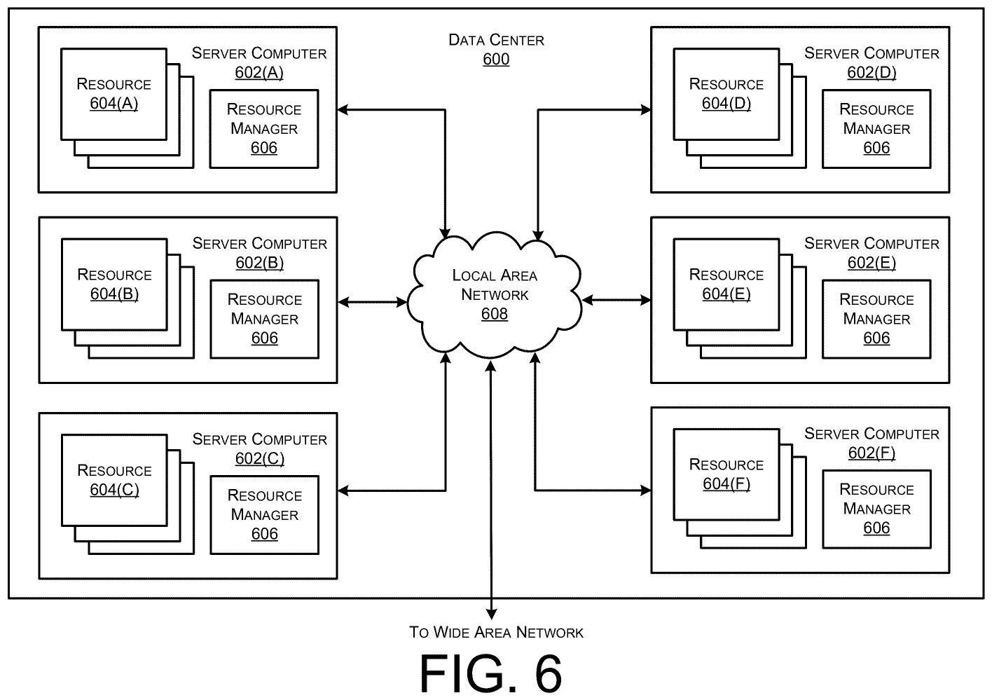

FIG. 6 is a computing system diagram illustrating a configuration for a data center 600 that can be utilized to implement aspects of the technologies disclosed herein. In one example, the data center 600 may be used to support the AI taster, such as AI taster 114. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the servers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the AI taster 114 and/or the service provider network 102.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

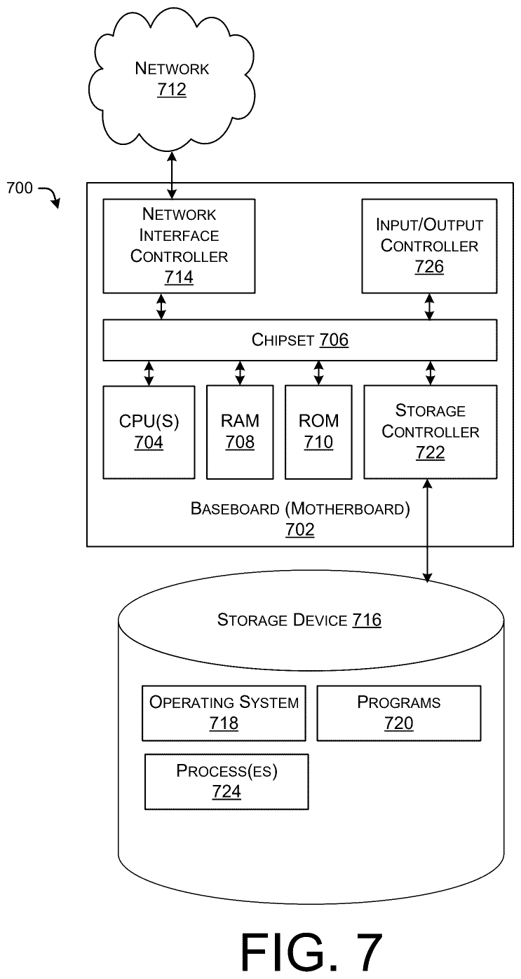

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a server computer 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The server computer 700 may, in some examples, correspond to a physical server and may comprise networked devices such as servers, switches, routers, hubs, bridges, gateways, modems, repeaters, access points, etc.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a random-access memory (RAM) 708, used as the main memory in the computer 700. The chipset 706 can further provide an interface to a computer-readable storage medium such as a read-only memory (ROM) 710 or non-volatile RAM (NVRAM) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 712. The chipset 706 can include functionality for providing network connectivity through a network interface controller (NIC) 714, such as a gigabit Ethernet adapter. The NIC 714 is capable of connecting the computer 700 to other computing devices over the network 712. It should be appreciated that multiple NICs 714 can be present in the computer 700, connecting the computer 700 to other types of networks and remote computer systems. In some instances, the NICs 714 may include at least on ingress port and/or at least one egress port.

The computer 700 can be connected to a storage device 716 that provides non-volatile storage for the computer. The storage device 716 can store an operating system 718, programs 720, and data, which have been described in greater detail herein. The storage device 716 can be connected to the computer 700 through a storage controller 722 connected to the chipset 706. The storage device 716 can consist of one or more physical storage units. The storage controller 716 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 700 can store data on the storage device 716 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 716 is characterized as primary or secondary storage, and the like.

For example, the computer 700 can store information to the storage device 716 by issuing instructions through the storage controller 722 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 716 by detecting the physical states or characteristics of one or more particular locations within the physical storage units.

In addition to the mass storage device 716 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by any network node described herein may be supported by one or more devices similar to computer 700. Stated otherwise, some or all of the operations performed by a network node may be performed by one or more computer devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 716 can store an operating system 718 utilized to control the operation of the computer 700. According to one embodiment, the operating system comprises the LINUX™ operating system. According to another embodiment, the operating system includes the WINDOWS™ SERVER operating system from MICROSOFT Corporation of Redmond, Washington. According to further embodiments, the operating system can comprise the UNIX™ operating system or one of its variants. It should be appreciated that other operating systems can also be utilized. The storage device 716 can store other system or application programs and data utilized by the computer 700.

In one embodiment, the storage device 716 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

As illustrated in FIG. 7, the storage device 716 stores programs 720, which may include one or more processes 724. The programs 720 may comprise any type of programs or processes to perform the techniques described in this disclosure for load-balancing user queries between AI and non-AI compute resources. That is, the computer 700 may comprise any one of the routers, load balancers, and/or servers. The programs 720 may comprise any type of program that cause the computer 700 to perform techniques for communicating with other devices using any type of protocol or standard usable for determining connectivity. The process(es) 724 may include instructions that, when executed by the CPU(s) 704, cause the computer 700 and/or the CPU(s) 704 to perform one or more operations.

The computer 700 can also include at least one input/output controller 726 for receiving and processing input from a number of input devices, such as a keyboard, a mouse, a touchpad, a touch screen, an electronic stylus, or other type of input device. Similarly, an input/output controller 726 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

As described herein, the computer 700 may comprise one or more of a router, load balancer, and/or server. The computer 700 may include one or more hardware processors 704 (processors) configured to execute one or more stored instructions. The processor(s) 704 may comprise one or more cores. Further, the computer 700 may include one or more network interfaces configured to provide communications between the computer 700 and other devices, such as the communications described herein as being performed by the router, load balancer, and/or server. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for load balancing user queries for artificial intelligence (AI) processing in a network, the method comprising:
receiving, at a network component configured to pre-process queries for AI processing, data indicating a user query for AI processing;
identifying metadata associated with the user query;
determining, based on at least one of the user query or the metadata, a processing requirement associated with the user query;
selecting, from among a first computing resource type and a second computing resource type, the first computing resource type as being more suitable for processing the user query than the second computing resource type based at least in part on the processing requirement, wherein the first computing resource type is an AI computing resource and the second computing resource type is a non-AI computing resource; and
sending the user query to the first computing resource type based at least in part on the selecting.

2. The method of claim 1, wherein the data is first data indicating a first user query, the processing requirement is a first processing requirement, and the metadata is first metadata, the method further comprising:
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the second computing resource type as being more suitable for processing the user query than the first computing resource type based at least in part on the second processing requirement; and
sending the second user query to the second computing resource type based at least in part on the selecting.

3. The method of claim 1, further comprising:
receiving, at the network component, user input data, wherein the user input data is responsive to a first output associated with the user query and the first computing resource type;
selecting, from among the first computing resource type and the second computing resource type, the second computing resource type for processing the user query based at least in part on the user input data;
sending the user query to be processed by the second computing resource type based at least in part on the selecting;
determining a comparison between the first output and a second output associated with the user query and the second computing resource type; and
determining a confidence score associated with the first computing resource type based at least in part on the comparison.

4. The method of claim 1, wherein the data is first data indicating a first user query, the processing requirement is a first processing requirement, and the metadata is first metadata, the method further comprising:
receiving, at the network component, user input data, wherein the user input data is responsive to an output associated with the first user query and the first computing resource type;
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the second computing resource type as being more suitable for processing the second user query than the first computing resource type based at least in part on the second processing requirement and the user input data; and
sending the second user query to the second computing resource type based at least in part on the selecting.

5. The method of claim 1, wherein the metadata includes an indication of:
a feature associated with a file included with the user query;
a file extension associated with the file; or
a feature associated with a user prompt included with the user query.

6. The method of claim 1, further comprising:
receiving, at the network component, configuration data indicating a configuration associated with the network; and
determining, based at least in part on the processing requirement and the configuration data, the first computing resource type as being more suitable for processing the user query.

7. The method of claim 6, wherein the configuration includes:
a threshold usage associated with the AI computing resource;
a threshold time associated with the AI computing resource;
a priority associated with a user;
a priority associated with the user query; or
computing resources available in the network.

8. A system comprising:
one or more processors; and
one or more non-transitory computer-readable media storing computer-executable instructions that, when executed by the one or more processors, cause the one or more processors to perform operations comprising:
receiving, at a network component configured to pre-process queries for AI processing, data indicating a user query for AI processing;
identifying metadata associated with the user query;
determining, based on at least one of the user query or the metadata, a processing requirement associated with the user query;
selecting, from among a first computing resource type and a second computing resource type, the second computing resource type as being more suitable for processing the user query than the first computing resource type based at least in part on the processing requirement, wherein the first computing resource type is an AI computing resource and the second computing resource type is a non-AI computing resource; and
sending the user query to the second computing resource type based at least in part on the selecting.

9. The system of claim 8, wherein the data is first data indicating a first user query, the processing requirement is a first processing requirement, and the metadata is first metadata, the operations further comprising:
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the first computing resource type as being more suitable for processing the user query than the second computing resource type based at least in part on the second processing requirement; and
sending the second user query to the first computing resource type based at least in part on the selecting.

10. The system of claim 9, the operations further comprising:
receiving, at the network component, user input data, wherein the user input data is responsive to a first output associated with the second user query and the first computing resource type;
selecting, from among the first computing resource type and the second computing resource type, the second computing resource type for processing the second user query based at least in part on the user input data;
sending the user query to be processed by the second computing resource type based at least in part on the selecting;
determining a comparison between the first output and a second output associated with the second user query and the first computing resource type; and
determining a confidence score associated with the first computing resource type based at least in part on the comparison.

11. The system of claim 8, wherein the data is first data indicating a first user query, the processing requirement is a first processing requirement, and the metadata is first metadata, the operations further comprising:
receiving, at the network component, user input data, wherein the user input data is responsive to an output associated with the first user query and the second computing resource type;
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the first computing resource type as being more suitable for processing the second user query than the second computing resource type based at least in part on the second processing requirement and the user input data; and
sending the second user query to the first computing resource type based at least in part on the selecting.

12. The system of claim 8, wherein the metadata includes an indication of:
a feature associated with a file included with the user query;
a file extension associated with the file; or
a feature associated with a user prompt included with the user query.

13. The system of claim 8, the operations further comprising:
receiving, at the network component, configuration data indicating a configuration associated with a network; and
determining, based at least in part on the processing requirement and the configuration data, the second computing resource type as being more suitable for processing the user query.

14. The system of claim 13, wherein the configuration includes:
a threshold usage associated with the AI computing resource;
a threshold time associated with the AI computing resource;
a priority associated with a user;
a priority associated with the user query; or
computing resources available in the network.

15. One or more non-transitory computer-readable media storing computer-executable instructions that, when executed by one or more processors, cause the one or more processors to perform operations comprising:
receiving, at a network component configured to pre-process queries for AI processing, data indicating a user query for AI processing;
identifying metadata associated with the user query;
determining, based on at least one of the user query or the metadata, a processing requirement associated with the user query;
selecting, from among a first computing resource type and a second computing resource type, the second computing resource type as being more suitable for processing the user query than the first computing resource type based at least in part on the processing requirement, wherein the first computing resource type is an AI computing resource and the second computing resource type is a non-AI computing resource; and
sending the user query to the second computing resource type based at least in part on the selecting.

16. The one or more non-transitory computer-readable media of claim 15, wherein the data is first data indicating a first user query, the processing requirement is a first processing requirement, and the metadata is first metadata, the operations further comprising:
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the first computing resource type as being more suitable for processing the user query than the second computing resource type based at least in part on the second processing requirement; and
sending the second user query to the first computing resource type based at least in part on the selecting.

17. The one or more non-transitory computer-readable media of claim 15, wherein the data is first data indicating a first user query, the processing requirement is a first processing requirement, and the metadata is first metadata, the operations further comprising:
receiving, at the network component, user input data, wherein the user input data is responsive to an output associated with the first user query and the second computing resource type;
receiving, at the network component, second data indicating a second user query for AI processing;
identifying second metadata associated with the second user query;
determining, based on at least one of the second user query or the second metadata, a second processing requirement associated with the second user query;
selecting, from among the first computing resource type and the second computing resource type, the first computing resource type as being more suitable for processing the second user query than the second computing resource type based at least in part on the second processing requirement and the user input data; and
sending the second user query to the first computing resource type based at least in part on the selecting.

18. The one or more non-transitory computer-readable media of claim 15, wherein the metadata includes an indication of:
a feature associated with a file included with the user query;
a file extension associated with the file; or
a feature associated with a user prompt included with the user query.

19. The one or more non-transitory computer-readable media of claim 15, the operations further comprising:
receiving, at the network component, configuration data indicating a configuration associated with a network; and
determining, based at least in part on the processing requirement and the configuration data, the second computing resource type as being more suitable for processing the user query.

20. The one or more non-transitory computer-readable media of claim 19, wherein the configuration includes:
a threshold usage associated with the AI computing resource;
a threshold time associated with the AI computing resource;
a priority associated with a user;
a priority associated with the user query; or
computing resources available in the network.
